(19) United States
(12) Patent Application Publication
(10) Pub. No.: US 2026/0350832 A1
(43) Pub. Date: Nov. 5, 2026

(54) Feedback-based 3D human pose reconstruction method, and lighting system

(71) Applicant: Guangzhou Haoyang Electronic Co., Ltd., Guangzhou (CN)

(72) Inventors: Yingru PENG, Guangzhou (CN); Weikai JIANG, Guangzhou (CN); Xianhua CHEN, Guangzhou (CN); Zhiguang LIANG, Guangzhou (CN)

(21) Appl. No.: 19/552,214

(22) Filed: Feb. 27, 2026

(30) Foreign Application Priority Data
Apr. 30, 2025 (CN) 202510575147.1

(51) Int. Cl. G06T 7/73; H05B 47/175

(52) U.S. Cl. CPC G06T 7/73; H05B 47/1975; G06T 2207/10028; G06T 2207/20221; G06T 2207/30196

(57) ABSTRACT

A feedback-based 3D human pose reconstruction method includes: predicting 3D positions of human keypoints at time t based on estimated 3D positions and motion information of the human keypoints at time t−1; associating actual 2D positions of the human keypoints captured by cameras at the time t with predicted 2D positions obtained by back-projecting the predicted 3D positions into an image coordinate system of each camera, to form a set of 2D joint points of the human keypoints at the time t; obtaining 3D joint point clouds for the human keypoints at the time t according to the set of 2D joint points of the human keypoints at the time t; fusing the 3D joint point clouds to obtain fused 3D positions of the human keypoints; and optimizing the fused 3D positions using a multi-view geometric parameter optimization method in combination with the actual 2D positions of the human keypoints.

### CROSS REFERENCE TO RELATED APPLICATIONS

The present disclosure claims priority from Chinese Application No. CN 202510575147.1 filed on Apr. 30, 2025, all of which are hereby incorporated herein by reference.

### TECHNICAL FIELD

The present disclosure relates to the field of human pose determination, and in particular, to a feedback-based 3D human pose reconstruction method and a lighting system.

### BACKGROUND

When cameras are used to capture a human body for continuous human pose determination, state information of human keypoints from a previous time is often utilized to predict state information of the human keypoints at a current time, so as to narrow down an identification range of the human keypoints in a current captured image or to evaluate the accuracy of currently captured and identified keypoint positions. However, due to a limited number of cameras or the occlusion of the human keypoints, a significant deviation from the actual situation may be caused gradually during continuous human pose determination, resulting in erroneous human pose determination.

### SUMMARY

To overcome at least one of the aforementioned defects in the prior art, the present disclosure provides a feedback-based 3D human pose reconstruction method. By back-projecting predicted 3D positions at time t and associating the predicted 3D positions with actual 2D positions, a plurality of 3D joint points corresponding to human keypoints are obtained, and estimated 3D positions of the human keypoints at the time t are obtained after fusion and optimization of the 3D joint points. These estimated 3D positions are more precise, reliable, and closer to actual situations.

To solve the above technical problems, the technical solution adopted by the present disclosure is: a feedback-based 3D human pose reconstruction method, including the following steps:
S1: predicting 3D positions of human keypoints at time t based on estimated 3D positions and motion information of the human keypoints at time t−1;
S2: associating a plurality of actual 2D positions of the human keypoints captured by cameras at the time t with a plurality of predicted 2D positions obtained by back-projecting the predicted 3D positions into an image coordinate system of each camera, to form a set of 2D joint points of the human keypoints at the time t;
S3: obtaining 3D joint point clouds for the human keypoints at the time t according to the set of 2D joint points of the human keypoints at the time t;
S4: fusing the 3D joint point clouds using a fusion algorithm to obtain fused 3D positions of the human keypoints; and
S5: optimizing the fused 3D positions using a multi-view geometric parameter optimization method in combination with the plurality of actual 2D positions of the human keypoints captured by the cameras at the time t, to obtain estimated 3D positions of the human keypoints at the time t.

According to the feedback-based 3D human pose reconstruction method, more possible positions of 2D joint points corresponding to one human keypoint are obtained by back-projecting the predicted 3D positions at the time t into the image coordinate system of each camera and associating the predicted 3D positions with the actual 2D positions. This feedback alleviates, to a certain extent, reconstruction errors caused by the failure to identify the actual 2D positions of the human keypoints at the current time, thereby improving overall robustness. A larger number of 2D joint points can result in denser 3D joint points, making the fused 3D positions more accurate. Moreover, the fused 3D positions are globally optimized using the multi-view geometric parameter optimization method to obtain the estimated 3D positions, which further enhances the precision and stability of human keypoint estimation. This solution can mitigate occlusion issues to a certain extent and produce more stable and accurate estimation results when there are a small number of cameras.

Further, between step S2 and step S3, the method further includes a verification step: verifying two 2D joint points from any two image coordinate systems in the set of 2D joint points using an epipolar RANSAC algorithm, to exclude a pair of 2D joint points with a large degree of deviation. Due to noise, occlusion, or other factors, errors may exist in the acquired human keypoint positions, leading to insufficiently precise associations. Excluding the pair of 2D joint points with a large degree of deviation using the epipolar RANSAC algorithm can not only reduce the computational load when reconstructing 3D joint points but also reduce noise in the 3D joint point clouds, thereby providing a more accurate initial value estimation for subsequent steps.

Further, in the verification step, Sampson error is employed to measure the degree of deviation of two 2D joint points from any two image coordinate systems under epipolar geometric constraints, the Sampson error is

$${E}_{Sampson} ( {x}_{1} , {x}_{2} ) = \frac{{( {x}_{2}^{τ} {Fx}_{1} )}^{2}}{{( {Fx}_{1} )}^{T} ( {Fx}_{1} ) + {( {F}^{T} {x}_{2} )}^{T} ( {F}^{T} {x}_{2} )} ,$$

where F is a 3×3 fundamental matrix representing a projection relationship between two camera views, x₁ and x₂ correspond to homogeneous coordinates of the two 2D joint points from any two image coordinate systems respectively, and the degree of deviation is considered acceptable when E_{Sampson}(x₁, x₂) is less than a predetermined threshold. The Sampson error measures the degree of deviation of matching point pairs x₁ and x₂ under epipolar geometric constraints. This metric takes into account a geometric error caused by the fundamental matrix F and is computationally more efficient and stable compared to other error metrics, especially when large-scale data is being processed.

Further, the predetermined threshold is γ², and γ is three times a mean of image noise standard deviations of images acquired by all cameras. Specifically, after the image noise of an image acquired by each camera is obtained, the standard deviation of each image noise is calculated, and the mean of all standard deviations is finally obtained. The predetermined threshold is the square of three times this mean.

Further, step S3 specifically includes: combining two 2D joint points from any two image coordinate systems in the set of 2D joint points, and forming 3D joint point clouds from all the calculated 3D joint points. This approach can form as many 3D joint points as possible, thereby making the 3D joint point clouds denser.

Further, in step S4, the 3D joint point clouds are fused using a gain Kalman filter to obtain fused 3D positions of the human keypoints. The Kalman filter has the advantage that the state information at the time t−1 can be used to provide a prior value for the estimation of the human keypoint positions at the time t, thereby achieving dynamic prediction of the human keypoint positions at the time t. In addition, the Kalman filter can effectively model noise in the system process and the observation process, and suppress measurement errors and noise interference by adaptively adjusting the filter gain. The Kalman filter can also correct potential outliers, thereby preventing the potential outliers from negatively impacting pose estimation results.

Further, step S4 specifically includes: denoting the 3D joint point clouds as B={b₁, b₂, . . . , bₙ}, where bᵥ=[xᵥ yᵥ zᵥ]^{T} represents coordinates (1≤v≤N) of a v^{th} 3D joint point, a mean of the 3D joint point clouds is

$$\overline{b} \to \frac{1}{N} {\sum }_{v = 1}^{N} {b}_{v} ,$$

and a covariance matrix is

$$R = \frac{1}{N - 1} {\sum }_{v = 1}^{N} ( {b}_{v} - \tilde{b} ) {( {b}_{v} - \tilde{b} )}^{T} = [ \begin{matrix}Var ( {x}_{v} ) & Cov ( {x}_{v} , {y}_{v} ) & Cov ( {x}_{v} , {z}_{v} ) \\ Cov ( {y}_{v} , {x}_{v} ) & Var ( {y}_{v} ) & Cov ( {y}_{v} , {z}_{v} ) \\ Cov ( {z}_{v} , {x}_{v} ) & Cov ( {z}_{v} , {y}_{v} ) & Var ( {z}_{v} )\end{matrix} ] ,$$

where Var(xᵥ), Var(yᵥ), and Var(zᵥ) represent variances of xᵥ, yᵥ, and zᵥ respectively, indicating the magnitude of measurement noise of coordinates of the v^{th} 3D joint point in a corresponding direction, and Cov(⋅, ⋅) represents a covariance between the components of the v^{th} 3D joint point on the corresponding two axes and the components of other 3D joint points on the corresponding two axes; and obtaining a predicted state

$${\hat{x}}_{t - 1}^{+} = A {\hat{x}}_{t - 1}^{-}$$

at the time t based on state information of the human keypoints at the time t−1, and predicating the covariance

$${P}_{t - 1}^{+} = {AP}_{t - 1}^{-} {A}^{T} + Q ,$$

where A is a state transition matrix,

$${\hat{x}}_{1 - 1}^{-}$$

is the state information at the time t−1, Pₜ₋₁⁻is a covariance matrix at the time t−1, Q is a process noise covariance matrix, and the Kalman gain is

$${K}_{t} = {P}_{t - 1}^{+} {{H}^{T} ( {HP}_{t - 1}^{+} {H}^{T} + R )}^{- 1} ,$$

where H is a measurement matrix with a structure being H=[I_{3×3} 0_{3×3}], I_{3×3} is a 3×3 identity matrix, 0_{3×3} is a 3×3 zero matrix, the state information at the time t is a covariance matrix is

$${\hat{x}}_{t}^{-} = {\hat{x}}_{t - 1}^{+} + {K}_{t} ( \overline{b} - H {\hat{x}}_{t - 1}^{+} ) ,$$

a covariance matrix is

$${P}_{t}^{-} = ( I - {K}_{t} H ) {P}_{t - 1}^{+} ,$$

and the fused 3D position is

$${\hat{b}}_{t} = H {\hat{x}}_{t}^{-} .$$

Calculating the mean of the 3D joint point clouds can achieve data smoothing, thereby reducing random errors; and the covariance matrix R is configured to characterize the uncertainty of the measurement data, thereby enabling the system to better adapt to observation noise and improving the robustness and accuracy of data processing.

Further, in step S5, the multi-view geometric parameter optimization method is bundle adjustment. The bundle adjustment optimizes the position estimation of 3D points by minimizing reprojection errors of the fused 3D positions. Specifically, the bundle adjustment combines the geometric constraints between images captured by different cameras and employs non-linear optimization techniques, aiming to solve for an optimal solution that conforms to multi-view geometric consistency by minimizing errors between perspectives.

Further, step S5 specifically includes: optimizing the fused 3D position by minimizing a loss function

$$L ( P , {\hat{b}}_{t} ) = min \frac{1}{{\sum }_{j = 1}^{M} δ ( {x}_{j} )} {\sum }_{j = 1}^{M} δ ( {x}_{j} ) ‖ {P}_{j} {\hat{b}}_{t} - {x}_{j} ‖$$

and taking the optimized 3D position as an estimated 3D position, where xⱼ denotes coordinates of the corresponding position \hat{b}ᵢ in the image coordinate system, δ(xⱼ) is an indicator function representing a detection confidence of xⱼ in the image coordinate system, and Pⱼ represents a transformation matrix for projecting the fused 3D position into the image coordinate system. Due to the existence of detection errors and projection errors, there is a certain deviation between the detected keypoints and the back-projected points of the 3D points. By minimizing this loss function, the bundle adjustment can further optimize the position estimation of 3D points on the basis of ensuring geometric consistency. This optimization process employs an iterative algorithm, and camera parameters and 3D point coordinates are updated via non-linear least squares in each iteration, thereby eventually converging to an optimal solution, which significantly improves the localization accuracy of the 3D points.

Further, after step S5, the method further includes step S6: obtaining motion information of the human keypoints at the time t based on the estimated 3D positions of the human keypoints at the time t−1. This facilitates subsequent prediction of the predicted 3D position of the human keypoints at time t+1.

The present disclosure further provides a lighting system, including cameras for capturing human body images, a processor for reconstructing a 3D human pose using any of the aforementioned feedback-based 3D human pose reconstruction methods, and a lighting fixture for projecting light according to the 3D human pose. The lighting fixture can accurately project light according to estimated 3D positions of human keypoints, thereby enabling efficient interaction and providing a better experience for audiences.

The present disclosure further provides a human body positioning method, especially for the light tracking the human body object on the stage. The method uses the 3D human pose reconstruction method in any case mentioned above to obtain the estimated 3D positions of human keypoints. In the method, the lighting fixture projects light according to the obtained estimated 3D positions of human keypoints. The method according to the present disclosure can obtain more accurate human position information, so that the lighting fixture can accurately project light, thereby achieving reliable real-time tracking.

The present disclosure further provides a computer device, including a memory storing a computer program and a processor. The steps of the 3D human pose reconstruction method or the human body positioning method in any case mentioned above are implemented when the processor executes the computer program.

The present disclosure further provides a non-transitory computer-readable storage medium, having a computer program stored therein. The steps of the method 3D human pose reconstruction method or the human body positioning method described in any case above are implemented when the computer program is executed by a processor.

### BRIEF DESCRIPTION OF THE DRAWINGS

FIG. 1 is a schematic flowchart of a feedback-based 3D human pose reconstruction method according to the present disclosure;

FIG. 2 is a schematic diagram of a process of determining estimated 3D positions of human keypoints at time t according to the present disclosure;

FIG. 3 is a schematic diagram of a principle of existence of epipolar errors;

FIG. 4 is a schematic diagram of comparison between 3D joint point clouds at the time t and actual 3D positions of the human keypoints;

FIG. 5 is a schematic diagram of a principle of bundle adjustment; and

FIG. 6 is a schematic structural diagram of a lighting system according to the present disclosure.

### DETAILED DESCRIPTION OF THE EMBODIMENTS

The accompanying drawings are for illustrative purposes only and should not be construed as a limitation on this patent. To better illustrate the embodiments, certain components in the drawings may be omitted, enlarged, or scaled down, which does not represent actual dimensions of a product. It can be understood by those skilled in the art that certain well-known structures and descriptions thereof in the drawings may be omitted. The positional relationships described in the drawings are for illustrative purposes only and should not be construed as a limitation on this patent.

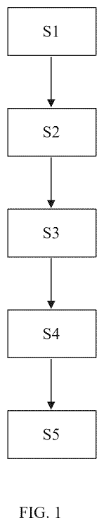

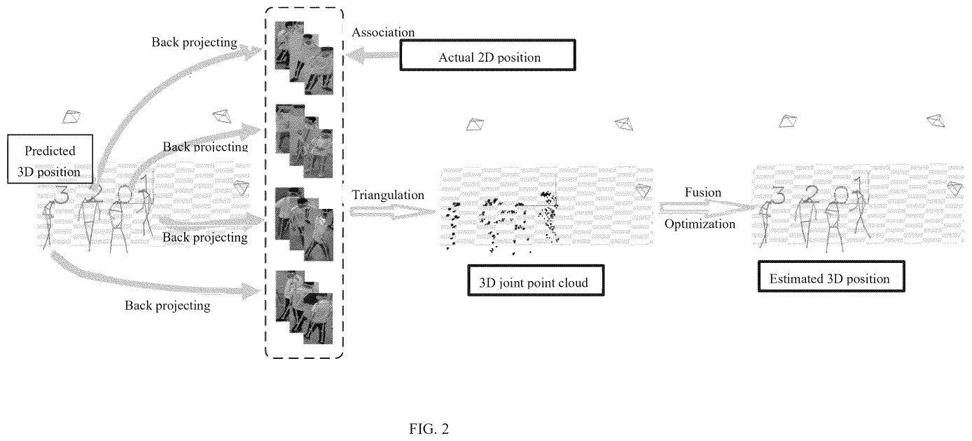

As shown in FIG. 1 and FIG. 2, the present disclosure provides a feedback-based 3D human pose reconstruction method, including the following steps S1 to S5.
Step S1: Predict 3D positions of human keypoints at time t based on estimated 3D positions and motion information of the human keypoints at time t−1.
Step S2: Associate a plurality of actual 2D positions of the human keypoints captured by cameras at time t with a plurality of predicted 2D positions obtained by back-projecting the predicted 3D positions into an image coordinate system of each camera, to form a set of 2D joint points of the human keypoints at the time t.
Step S3: Obtain 3D joint point clouds for the human keypoints at the time t according to the set of 2D joint points of the human keypoints at the time t.
Step S4: Fuse the 3D joint point clouds using a fusion algorithm to obtain fused 3D positions of the human keypoints.
Step S5: Optimize the fused 3D positions using a multi-view geometric parameter optimization method in combination with the plurality of actual 2D positions of the human keypoints captured by the cameras at the time t, to obtain estimated 3D positions of the human keypoints at the time t.

According to the feedback-based 3D human pose reconstruction method, more possible positions of 2D joint points corresponding to one human keypoint are obtained by back-projecting the predicted 3D positions at the time t into the image coordinate system of each camera and associating the predicted 3D positions with the actual 2D positions. This feedback alleviates, to a certain extent, reconstruction errors caused by the failure to identify the actual 2D positions of the human keypoints at the current time, thereby improving overall robustness. A larger number of 2D joint points can result in denser 3D joint points, making the fused 3D positions more accurate. Moreover, the fused 3D positions are globally optimized using the multi-view geometric parameter optimization method to obtain the estimated 3D positions, which further enhances the precision and stability of human keypoint estimation. This solution can mitigate occlusion issues to a certain extent and produce more stable and accurate estimation results when there are a small number of cameras In this embodiment, the motion information includes velocity and direction.

In steps S1 and S2, assuming that the human keypoint

$${H}_{t - 1}^{k -}$$

at the time t−1 corresponds to the plurality of actual 2D positions at the time t, an extended Kalman filter is used in the image coordinate system of the camera

$${H}_{t - 1}^{k -}$$

to obtain a set

$${S}_{k , t - 1} = \{ {𝒫}_{k , t - 1}^{1 +} , {𝒫}_{k , t - 1}^{2 +} , … , {𝒫}_{k , t - 1}^{j +} \vert j < J \}$$

of back-projected predicted 3D positions at the time t, while the set of the plurality of actual 2D positions is

$${C}_{{k}^{′} t}^{𝒫} = \{ {𝒫}_{{k}^{′} t}^{1} , {𝒫}_{{k}^{′} t}^{2} , … , {𝒫}_{{k}^{′} t}^{j} \vert j < J \} ,$$

and the corresponding human keypoints are extracted according to keypoint labels. Therefore, the set of 2D joint points may be represented as

$${Z}_{u , {k}^{′}} = \{ {𝒫}_{u , {k}^{′} , t}^{1} , {𝒫}_{u , {k}^{′} , t}^{2} , … , {𝒫}_{u , {k}^{′} , t}^{j} \vert j < J \} ⋃ \{ {𝒫}_{u , k , t - 1}^{1 +} , {𝒫}_{u , k , t - 1}^{2 +} , … , {𝒫}_{u , k , t - 1}^{j +} \vert j < J \} .$$

By merging the data in the set, the reconstructed set may be represented as

$${Z}_{u , k} = \{ {𝒫}_{u , k , t}^{j} , {𝒫}_{u , k , t - 1}^{j +} \vert j < J \} .$$

It should be noted that the predicted 3D position and motion information at the third time are calculated according to the actual 3D positions of the human keypoints at the first time and the second time. The predicted 3D position and motion information at the third time are used as its estimated 3D position and motion information for subsequent calculation. Therefore, the true estimated 3D position and motion information are only obtained starting from the fourth time. Therefore, in this application, t≥5.

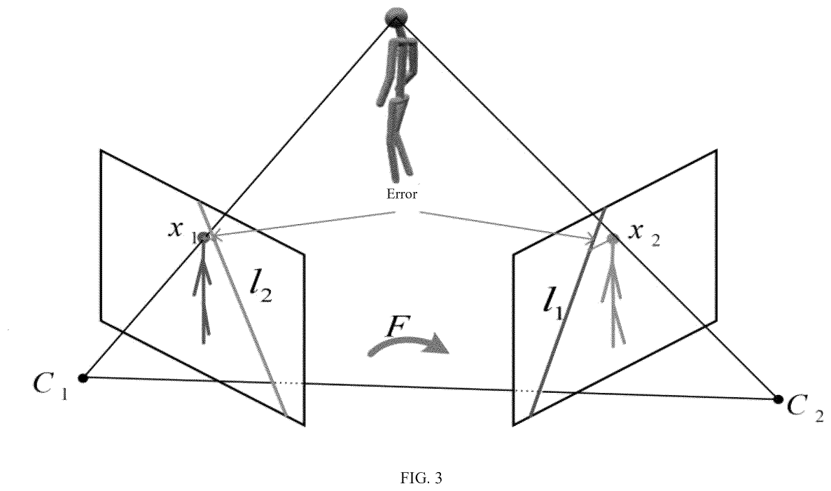

In a preferred embodiment of the present disclosure, between step S2 and step S3, the method further includes a verification step: verifying two 2D joint points from any two image coordinate systems in the set of 2D joint points using an epipolar RANSAC algorithm (i.e., epipolar random sample consensus algorithm), to exclude a pair of 2D joint points with a large degree of deviation. Due to noise, occlusion, or other factors, errors may exist in the acquired human keypoint positions, leading to insufficiently precise associations. As shown in FIG. 3, the situation where matching points deviate from their ideal corresponding positions, i.e., the existence of epipolar errors, is visually demonstrated, where I₁ and I₂ are epipolar lines of x₁ and x₂ respectively. Excluding the pair of 2D joint points with a large degree of deviation using the epipolar RANSAC algorithm (however, any one of the 2D joint points can be matched and verified again with other 2D joint points) can not only reduce the computational load during reconstruction of 3D joint points, but also reduce noise in the 3D joint point cloud, thereby providing a more accurate initial value estimation for subsequent steps.

In FIG. 3, the epipolar geometric relationship between two views describes how the projections of the same 3D point on image planes are mutually constrained under two camera perspectives. The epipolar geometric relationship is typically represented by a fundamental matrix F.

Specifically, the fundamental matrix F is a 3×3 matrix configured to describe a projection relationship between the two camera perspectives. Ideally, two given points x₁ and x₂ in the images (corresponding to points in the first view and the second view, respectively) need to satisfy the following relationship:

$${x}_{2}^{T} {Fx}_{1} = 0 ,$$

where
x₁ and x₂ are homogeneous coordinates on the image planes. This equation indicates that the relationship between the point x₂ in the second view and the point x₁ in the first view is restricted, that is, for each pair of matching points, the fundamental matrix provides a geometric constraint.

The geometric significance of this relationship lies in that the epipole refers to a point of intersection of the line of sight of a point in one view with an optical axis of the camera in the other view. Correspondingly, all points in the second view need to lie on an epipolar line. The fundamental matrix describes the correspondence between these points and lines.

In practical applications, due to the existence of noise and measurement errors, the aforementioned equation

$${x}_{2}^{T} {Fx}_{1} = 0$$

does not hold strictly. Therefore, it is necessary to introduce an error metric to quantify the degree of deviation of the matching points under the epipolar geometric constraints.

In a preferred embodiment of the present disclosure, in the verification step, Sampson error is employed to measure the degree of deviation of two 2D joint points from any two image coordinate systems under epipolar geometric constraints, the Sampson error is

$${E}_{Sampson} ( {x}_{1} , {x}_{2} ) = \frac{{( {x}_{2}^{T} {Fx}_{1} )}^{2}}{{( {Fx}_{1} )}^{T} ( {Fx}_{1} ) + {( {F}^{T} {x}_{2} )}^{T} ( {F}^{T} {x}_{2} )} ,$$

where F is a 3×3 fundamental matrix representing a projection relationship between two camera views, x₁ and x₂ correspond to homogeneous coordinates of the two 2D joint points from any two image coordinate systems respectively, and the degree of deviation is considered acceptable when E_{Sampson}(x₁, x₂) is less than a predetermined threshold. The Sampson error measures the degree of deviation of the matching point pairs x₁ and x₂ under epipolar geometric constraints. This metric takes into account the geometric error caused by the fundamental matrix F and is computationally more efficient and stable compared to other error metrics, especially when large-scale data is being processed.

In a preferred embodiment of the present disclosure, the predetermined threshold is γ², and γ is three times a mean of image noise standard deviations of the images acquired by all cameras. Specifically, after the image noise of an image acquired by each camera is obtained, the standard deviation of each image noise is calculated, and the mean of all standard deviations is finally obtained. The predetermined threshold is the square of three times this mean. If the Sampson error of two 2D joint points from any two image coordinate systems exceeds the predetermined threshold, this pair will not be configured to calculate 3D joint points subsequently.

In a preferred embodiment of the present disclosure, step S3 specifically includes: combining two 2D joint points from any two image coordinate systems in the set of 2D joint points, and forming the 3D joint point clouds from all the calculated 3D joint points. Corresponding 3D joint points can be obtained from two 2D joint points from any two image coordinate systems using triangulation. This approach can form as many 3D joint points as possible, thereby making the 3D joint point clouds denser to facilitate the precise determination of human keypoint positions.

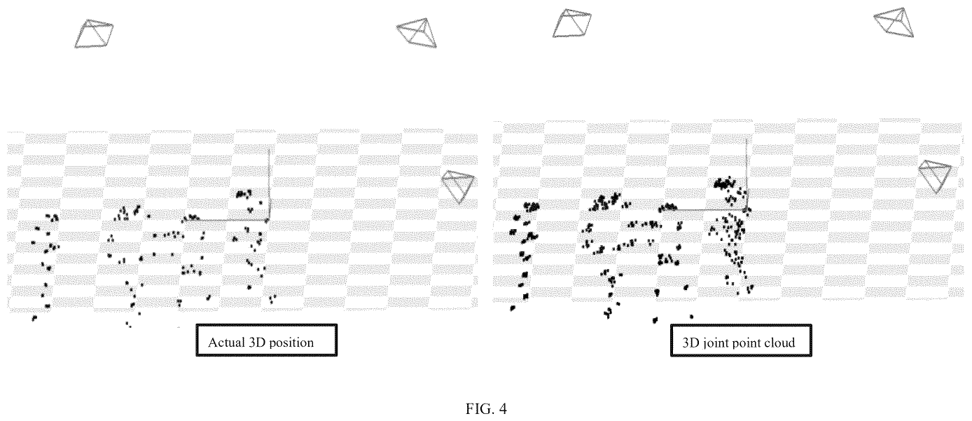

As shown in FIG. 4, after the feedback of the predicted 3D positions predicted at the time t−1, the 3D joint point clouds at the time t are generated using the obtained set of 2D joint points. Compared to the actual 3D positions directly captured and identified by the cameras at the time t (calculated from the plurality of actual 2D positions), the point clouds are significantly denser, thereby improving the accuracy of the human keypoint position.

In a preferred embodiment of the present disclosure, in step S4, the 3D joint point clouds are fused using a gain Kalman filter to obtain the fused 3D positions of the human keypoints. The Kalman filter has the advantages that the state information at the time t−1 can be used to provide a prior value for the estimation of the human keypoint positions at the time t, thereby achieving dynamic prediction of the human keypoint positions at the time t. In addition, the Kalman filter can effectively model noise in the system process and the observation process, and suppress measurement errors and noise interference by adaptively adjusting the filter gain. The Kalman filter can also correct potential outliers, thereby preventing the potential outliers from negatively impacting pose estimation results.

The state information includes the estimated 3D positions and motion information of the human keypoints, where the motion information includes velocity and direction.

In a preferred embodiment of the present disclosure, step S4 specifically includes: denoting the 3D joint point cloud as B={b₁, b₂, . . . , bᵥ}, where bᵥ=[xᵥ yᵥ zᵥ]^{T} represents coordinates (1≤v≤N) of the v^{th} 3D joint point, a mean of the 3D joint point clouds is

$$\overline{b} = \frac{1}{N} {\sum }_{v = 1}^{N} {b}_{v} ,$$

and a covariance matrix is

$$R = \frac{1}{N - 1} {\sum }_{v = 1}^{N} ( {b}_{v} - \overline{b} ) {( {b}_{v} - \overline{b} )}^{T} = [ \begin{matrix}Var ( {x}_{v} ) & Cov ( {x}_{v} , {y}_{v} ) & Cov ( {x}_{v} , {z}_{v} ) \\ Cov ( {y}_{v} , {x}_{v} ) & Var ( {y}_{v} ) & Cov ( {y}_{v} , {z}_{v} ) \\ Cov ( {z}_{v} , {x}_{v} ) & Cov ( {z}_{v} , {y}_{v} ) & Var ( {z}_{v} )\end{matrix} ] ,$$

where Var(xᵥ), Var(yᵥ), and Var(zᵥ) represent variances of xᵥ, yᵥ, and zᵥ respectively, indicating the magnitude of measurement noise of coordinates of the v^{th} 3D joint point in a corresponding direction, and Cov(⋅, ⋅) represents a covariance between the components of a v^{th} 3D joint point on the corresponding two axes and the components of other 3D joint points on the corresponding two axes; and obtaining a predicted state

$${\hat{x}}_{t - 1}^{+} = A {\hat{x}}_{t - 1}^{-}$$

at the time t based on state information of the human keypoints at the time t−1, and predicating the covariance

$${P}_{t - 1}^{+} = {AP}_{t - 1}^{-} {A}^{T} + Q ,$$

where A is a state transition matrix, \hat{x}ₜ₋₁⁻ is the state information at the time t−1,

$${P}_{t - 1}^{-}$$

is a covariance matrix at the time t−1, Q is a process noise covariance matrix, and the Kalman gain is

$${K}_{t} = {P}_{t - 1}^{+} {{H}^{T} ( {HP}_{t - 1}^{+} {H}^{T} + R )}^{- 1} ,$$

where H is a measurement matrix with a structure being H=[I_{3×3} 0_{3×3}], I_{3×3} is a 3×3 identity matrix, 0_{3×3} is a 3×3 zero matrix, the state information at the time t is

$${\hat{x}}_{t}^{-} = {\hat{x}}_{t - 1}^{+} + {K}_{t} ( \overline{b} - H {\hat{x}}_{t - 1}^{+} ) ,$$

a covariance matrix is

$${P}_{t}^{-} = ( I - {K}_{t} H ) {P}_{t - 1}^{+} ,$$

and the fused 3D position is

$${\hat{b}}_{t} = H {\hat{x}}_{t}^{-}$$

Cov (xᵥ, yᵥ) and Cov Cov (yᵥ, xᵥ) represent the covariance between the components of the v^{th} 3D joint point on the y-axis and x-axis and the corresponding components of other 3D joint points, Cov (xᵥ, zᵥ) and Cov (z_{y}, xᵥ) represent the covariance between the components of the v^{th} 3D joint point on the z-axis and x-axis and the corresponding components of other 3D joint points, and Cov (z_{y}, yᵥ) and Cov (yᵥ, zᵥ) represent the covariance between the components of the v^{th} 3D joint point on the y-axis and z-axis and the corresponding components of other 3D joint points. Cov (xᵥ, yᵥ), Cov Cov (yᵥ, xᵥ), Cov (xᵥ, zᵥ), Cov (z_{y}, xᵥ), Cov (z_{y}, yᵥ), and Cov (yᵥ, zᵥ) jointly represent the correlation between the components of the v^{th} 3D joint point on the x, y, and z axes and the corresponding components of other 3D joint points.

Calculating the mean of the 3D joint point clouds achieves data smoothing, thereby reducing random errors; and the covariance matrix R is configured to characterize the uncertainty of the measurement data, thereby enabling the system to better adapt to observation noise and improving the robustness and accuracy of data processing.

In a preferred embodiment of the present disclosure, in step S5, the multi-view geometric parameter optimization method is bundle adjustment. The bundle adjustment optimizes the position estimation of 3D points by minimizing reprojection errors of the fused 3D positions. Specifically, the bundle adjustment combines the geometric constraints between images captured by different cameras and employs non-linear optimization techniques, aiming to solve for an optimal solution that conforms to multi-view geometric consistency by minimizing the errors between perspectives.

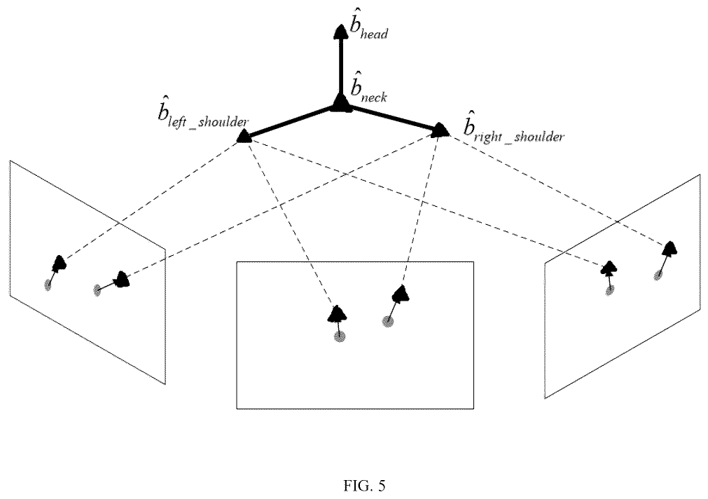

As shown in FIG. 5, the principle of bundle adjustment (BA) is illustrated. In the views, circular points represent keypoints identified by a detector, while triangular points represent positions, at which the reconstructed keypoints are projected, on the view planes. Due to the existence of detection errors and projection errors, there is a certain deviation between the detected keypoints and the projected points.

In a preferred embodiment of the present disclosure, step S5 specifically includes: optimizing the fused 3D position by minimizing a loss function

$$L ( P , {\hat{b}}_{i} ) = min \frac{1}{{\sum }_{j = 1}^{M} δ ( {x}_{j} )} {\sum }_{j = 1}^{M} δ ( {x}_{j} ) ‖ {P}_{i} {\hat{b}}_{i} - {x}_{j} ‖$$

and taking the optimized 3D position as an estimated 3D position, where xⱼ denotes coordinates of the corresponding position \hat{b}ₗ in the image coordinate system, δ (xⱼ) is an indicator function representing the confidence that xⱼ is detected in the image coordinate system, and Pⱼ represents a transformation matrix for projecting the fused 3D position into the image coordinate system. Due to the existence of detection errors and projection errors, there is a certain deviation between the detected keypoints and the back-projected points of the 3D points. The loss function primarily measures the sum of reprojection errors across all views. By minimizing this loss function, bundle adjustment can further optimize the position estimation of 3D points on the basis of ensuring geometric consistency. This optimization process employs an iterative algorithm, and camera parameters and coordinates of 3D points are updated via non-linear least squares in each iteration, thereby eventually converging to an optimal solution, which significantly improves the localization accuracy of the 3D points.

It should be noted that during minimizing of the loss function, the true positions of human keypoints on the image are usually unknown (the detected ones are not necessarily the true ones).

This application addresses this issue by treating human keypoints with the confidence xⱼ greater than 0.3 as true values.

In a preferred embodiment of the present disclosure, after step S5, the method further includes step S6: obtaining motion information of the human keypoints at the time t based on the estimated 3D positions of the human keypoints at the time t−1. This facilitates subsequent prediction of the predicted 3D positions of the human keypoints at time t+1.

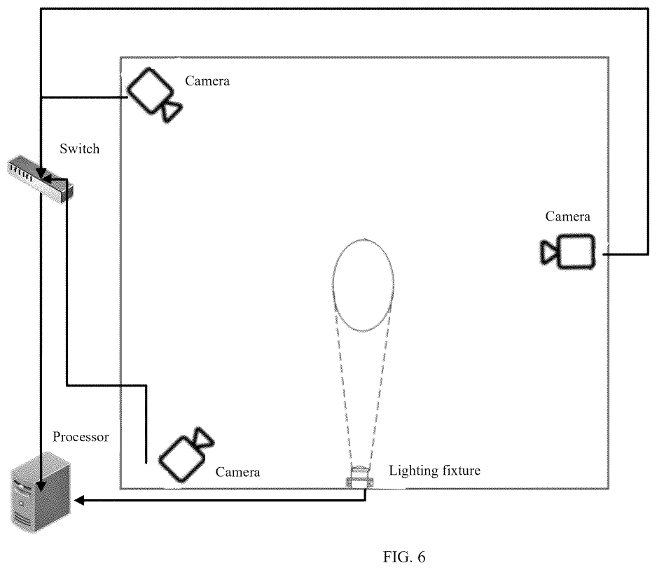

As shown in FIG. 6, the present disclosure further provides a lighting system, including cameras for capturing human body images, a processor for reconstructing a 3D human pose using any of the aforementioned feedback-based 3D human pose reconstruction methods, and a lighting fixture for projecting light according to the 3D human pose. The lighting fixture can accurately project light according to the estimated 3D positions of human keypoints, thereby enabling efficient interaction and providing a better experience for audiences.

A human body positioning method is provided according to an embodiment of the present disclosure, which is especially used for the light tracking the human body object on the stage. The method uses the 3D human pose reconstruction method in any embodiment mentioned above to obtain the estimated 3D positions of human keypoints. In the present method, the lighting fixture projects light according to the obtained estimated 3D positions of human keypoints. The method according to the present embodiment can obtain more accurate human position information, so that the lighting fixture can accurately project light, thereby achieving reliable real-time tracking.

A computer device is provided according to an embodiment of the present disclosure. The computer device may be a terminal. The computer device includes a processor, a memory, a communication interface, a display screen and an input device connected via a system bus. The processor of the computer device is used for providing computing and control capabilities. The memory includes an operating system in a non-volatile storage medium and an environment for running a computer program. The communication interface is used for communication with an external terminal in a wired or wireless manner. The wireless manner can be realized through WiFi, NFC (near field communication) or other technologies. When the computer program is executed by the processor, the steps of the 3D human pose reconstruction method or the human body positioning method in any embodiment mentioned above is implemented.

A computer-readable storage medium is provided according to an embodiment of the present disclosure, in which a computer program is stored. When the computer program is executed by a processor, the steps of the 3D human pose reconstruction method or the human body positioning method in any embodiment mentioned above is implemented.

It is apparent that those skilled in the art should know that each step of the present disclosure may be implemented by a universal computing device, and the steps may be concentrated on a single computing device or distributed on a network formed by a plurality of computing devices, and may optionally be implemented by program codes executable for the computing devices, so that the steps may be stored in a storage device for execution with the computing devices, the shown or described steps may be executed in sequences different from those described here in some circumstances, or may form each integrated circuit module respectively, or multiple steps therein may form a single integrated circuit module for implementation. Therefore, the present disclosure is not limited to any specific hardware and software combination.

Obviously, the aforementioned embodiments of the present disclosure are merely examples provided for clear illustration and are not intended to limit the implementation of the present disclosure. For those of ordinary skill in the art, other changes or variations in different forms can also be made based on the above description. It is neither necessary nor possible to exhaustively list all implementations here. Any modifications, equivalent substitutions, and improvements made within the spirit and principles of the present disclosure shall fall within the scope of protection of the claims of the present disclosure.

What is claimed is:

1. A feedback-based 3D human pose reconstruction method, comprising steps of:
S1) predicting 3D positions of human keypoints at time t based on estimated 3D positions and motion information of the human keypoints at time t−1;
S2) associating a plurality of actual 2D positions of the human keypoints captured by cameras at the time t with a plurality of predicted 2D positions obtained by back-projecting the predicted 3D positions into an image coordinate system of each camera, to form a set of 2D joint points of the human keypoints at the time t;
S3) obtaining 3D joint point clouds for the human keypoints at the time t according to the set of 2D joint points of the human keypoints at the time t;
S4) fusing the 3D joint point clouds using a fusion algorithm to obtain fused 3D positions of the human keypoints; and
S5) optimizing the fused 3D positions using a multi-view geometric parameter optimization method in combination with the plurality of actual 2D positions of the human keypoints captured by the cameras at the time t, to obtain estimated 3D positions of the human keypoints at the time t.

2. The feedback-based 3D human pose reconstruction method according to claim 1, wherein between step S2 and step S3, the method further comprises a verification step: verifying two 2D joint points from any two image coordinate systems in the set of 2D joint points using an epipolar RANSAC algorithm, to exclude a pair of 2D joint points with a large degree of deviation.

3. The feedback-based 3D human pose reconstruction method according to claim 2, wherein in the verification step, Sampson error is employed to measure the degree of deviation of two 2D joint points from any two image coordinate systems under epipolar geometric constraints, the Sampson error is
$${E}_{Sampson} ( {x}_{1} , {x}_{2} ) = \frac{{( {x}_{2}^{T} {Fx}_{1} )}^{2}}{{( {Fx}_{1} )}^{T} ( {Fx}_{1} ) + {( {F}^{T} {x}_{2} )}^{T} ( {F}^{T} {x}_{2} )} ,$$
wherein F is a 3×3 fundamental matrix representing a projection relationship between two camera views, x₁ and x₂ correspond to homogeneous coordinates of the two 2D joint points from any two image coordinate systems respectively, and the degree of deviation is considered acceptable when E_{Sampson}(x₁, ₂) is less than a predetermined threshold.

4. The feedback-based 3D human pose reconstruction method according to claim 3, wherein the predetermined threshold is γ², and γ is three times a mean of image noise standard deviations of images acquired by all cameras.

5. The feedback-based 3D human pose reconstruction method according to claim 1, wherein step S3 comprises: combining two 2D joint points from any two image coordinate systems in the set of 2D joint points, and forming 3D joint point clouds from all the calculated 3D joint points.

6. The feedback-based 3D human pose reconstruction method according to claim 1, wherein in step S4, the 3D joint point clouds are fused using a gain Kalman filter to obtain fused 3D positions of the human keypoints.

7. The feedback-based 3D human pose reconstruction method according to claim 6, wherein step S4 comprises: denoting the 3D joint point clouds as B={b₁, b₂, . . . , bᵥ}, wherein bᵥ=[xᵥ yᵥ zᵥ]^{T} represents coordinates (1≤v≤N) of a v^{th} 3D joint point, a mean of the 3D joint point clouds is
$$\overline{b} = \frac{1}{N} {\sum }_{v = 1}^{N} {b}_{v} ,$$
and a covariance matrix is
$$R = \frac{1}{N - 1} {\sum }_{v = 1}^{N} ( {b}_{v} - \overline{b} ) {( {b}_{v} - \overline{b} )}^{T} = [ \begin{matrix}Var ( {x}_{v} ) & Cov ( {x}_{v} , {y}_{v} ) & Cov ( {x}_{v} , {z}_{v} ) \\ Cov ( {y}_{v} , {x}_{v} ) & Var ( {y}_{v} ) & Cov ( {y}_{v} , {x}_{v} ) \\ Cov ( {z}_{v} , {x}_{v} ) & Cov ( {z}_{v} , {y}_{v} ) & Var ( {z}_{v} )\end{matrix} ] ,$$
wherein Var(xᵥ), Var(yᵥ), and Var(zᵥ) represent variances of x_{y}, yᵥ, and zᵥ respectively, indicating the magnitude of measurement noise of coordinates of the v^{th} 3D joint point in a corresponding direction, and Cov(⋅,⋅) represents a covariance between components of the v^{th} 3D joint point on two axes and components of other 3D joint points on the corresponding two axes; and obtaining a predicted state
$${\hat{x}}_{t - 1}^{+} = A {\hat{x}}_{t - 1}^{-}$$
at the time t based on state information of the human keypoints at the time t−1, and predicating the covariance
$${P}_{t - 1}^{+} = {AP}_{t - 1}^{-} {A}^{T} + Q ,$$
wherein A is a state transition matrix,
$${\hat{x}}_{t - 1}^{-}$$
is the state information at the time t−1,
$${P}_{t - 1}^{-}$$
is a covariance matrix at the time t−1, Q is a process noise covariance matrix, and the Kalman gain is
$${K}_{t} = {P}_{t - 1}^{+} {{H}^{T} ( {HP}_{t - 1}^{+} {H}^{T} + R )}^{- 1} ,$$
wherein H is a measurement matrix with a structure being H=[I_{3×3} 0_{3×3}], I_{3×3} is a 3×3 identity matrix, 0_{3×3} is a 3×3 zero matrix, the state information at the time t is
$${\hat{x}}_{t}^{-} = {\hat{x}}_{t - 1}^{+} + {K}_{t} ( \overline{b} - H {\hat{x}}_{t - 1}^{+} ) ,$$
a covariance matrix is
$${P}_{t}^{-} = ( I - {K}_{t} H ) {P}_{t - 1}^{+} ,$$
and the fused 3D position is
$${\hat{b}}_{t} = H {\hat{x}}_{t}^{-} .$$

8. The feedback-based 3D human pose reconstruction method according to claim 1, wherein in step S5, the multi-view geometric parameter optimization method is bundle adjustment.

9. The feedback-based 3D human pose reconstruction method according to claim 8, wherein step S5 comprises: optimizing the fused 3D position by minimizing a loss function
$$L ( P , {\hat{b}}_{i} ) = min \frac{1}{{\sum }_{j = 1}^{M} δ ( {x}_{j} )} {\sum }_{j = 1}^{M} \hat{o} ( {x}_{j} ) ‖ {P}_{i} {\hat{b}}_{i} - {x}_{j} ‖$$
and taking the optimized 3D position as an estimated 3D position, wherein xⱼ denotes coordinates of the corresponding position \hat{b}ₗ in the image coordinate system, δ(xⱼ) is an indicator function representing a detection confidence of xⱼ in the image coordinate system, and Pⱼ represents a transformation matrix for projecting the fused 3D position into the image coordinate system.

10. The feedback-based 3D human pose reconstruction method according to claim 1, wherein after step S5, the method further comprises step S6: obtaining motion information of the human keypoints at the time t based on the estimated 3D positions of the human keypoints at the time t−1.

11. A lighting system, comprising cameras for capturing human body images, a processor for reconstructing a 3D human pose using the feedback-based 3D human pose reconstruction method according to claim 1, and a lighting fixture for projecting light according to the 3D human pose.

12. A human body positioning method, comprising steps of:
obtaining estimated 3D positions of human keypoints at time t according to the method of claim 1; and
projecting light, by a lighting fixture, according to the obtained estimated 3D positions of the human keypoints.

13. A computer device, comprising a memory storing a computer program and a processor, wherein the steps of the method according to claim 1 are implemented when the processor executes the computer program.

14. A non-transitory computer-readable storage medium, having a computer program stored therein, wherein the steps of the method according to claim 1 are implemented when the computer program is executed by a processor.
